(19) United States
(12) Patent Application Publication
(10) Pub. No.: US 2012/0037664 A1
(43) Pub. Date: Feb. 16, 2012

(54) HANDS FREE SANITARY LIQUID DISPENSER FOR A COMPUTER STATION

(76) Inventor: BRETT DAGEL, OMAHA, NE (US)

(21) Appl. No.: 12/854,287

(22) Filed: Aug. 11, 2010

(51) Int. Cl. B67D 7/06

(52) U.S. Cl. 222/192

(57) ABSTRACT

A sanitary liquid dispenser for dispensing sanitary liquid and controlling use of an electronic device comprising: an outlet, where said outlet includes a means for the dispensing of sanitary liquid from a container within the dispenser; an emission sensor, where said emission sensor provides a means for dispensing sanitary liquid out of the outlet; a bottom lip, where said lip extends outwardly from the dispenser; and an electronic sensor, where said sensor transmits a signal via USB or other connection device to software residing on the electronic device and upon receipt of the signal, the software activates the electronic device for use.

### BACKGROUND OF THE INVENTION

1. Field of Invention

The present invention relates to a sanitary liquid dispenser that attaches to a computer station or sits on the desk beside the computer, and controls the use of a computer or other computerized device via a USB cable (or other connection device) and software program.

2. Description of Related Art

Greater attention in methods and devices to prevent the spread of bacteria, viruses or other germs has been recently developed. Many individuals take great care in frequently washing their hands and avoiding direct contact with germ-infested devices or environments. This is particularly true in public places where a number of people may transmit various bacteria and germs. Some people have resorted to keeping a supply of sanitary gel or cream with them at all times so that they can frequently wipe their hands of potential bacteria or germs. Sanitizing liquid gel dispensers have been installed in many public bathrooms and in public areas. Further individuals may carry containers of towelettes that include sanitizing liquids so that they may use them as needed throughout the day.

Many people may need to access computers, ATM'S or other electronic devices in public areas to do research or retrieve stored data for a particular activity or to conduct transactions. Computer screens and keyboards are used throughout the public environment due to their heavy integration in society. Keyboards and monitors are used to conduct sales transactions, research data in a library or courthouse, compile and retrieve in a health facility and other computers are available for temporary use in certain locations such as an internet café or airport. Since this transient use of computers and other electronic devices creates the potential for the spread of disease and bacteria, it would be advantageous to have a means to conveniently sanitize one's hands either prior to and directly after using the computerized equipment. It would also be advantageous to have a sanitary liquid dispenser readily available near the computer station, ATM or other electronic device.

### SUMMARY OF THE INVENTION

The present invention relates to a sanitary liquid dispenser for dispensing sanitary liquid and controlling use of a computer comprising: an outlet, where said outlet includes a means for the dispensing of sanitary liquid from a container within the dispenser; an emission sensor, where said emission sensor provides a means to emit a portion of the sanitary liquid; a bottom lip, where said lip extends outwardly from the dispenser; and an electronic sensor or card reader, where said sensor transmits a signal via USB cable or other connection device to software residing on the computer and upon receipt of the signal, the software activates the computer or other device for use. In one particular embodiment, the dispenser may store a refillable container of sanitary liquid and may be at least 9 inches in length, but dimensions may be altered to other suitable embodiments based upon various applications.

### BRIEF DESCRIPTION OF DRAWINGS

FIG. 1A depicts a sanitary liquid dispenser for dispensing sanitary liquid according to the present invention.

FIG. 1B depicts a stand for a sanitary liquid dispenser according to the present invention.

FIG. 2 depicts the sanitary liquid dispenser for dispensing sanitary liquid according to the present invention as may be used with a computing system.

FIG. 3 depicts an alternative embodiment of a sanitary liquid dispenser for dispensing sanitary liquid according to the present invention.

### DETAILED DESCRIPTION

The present invention relates to a sanitary liquid dispenser that may be attached to a computer, ATM or other computerized device to provide a convenient means for the dispensing of sanitary liquid. In one particular embodiment, the dispenser according to the invention attaches to the side of the device so that the liquid is readily available for use by the user. In an alternative embodiment, the dispenser could be placed in a stand beside the computer. The dispenser according to the present invention includes a means to activate the dispenser prior to operating the computer system. Software residing on the computer and linked with the dispenser disables the computer until a user uses the dispenser. The dispenser is particularly useful in case of a public or communal computer system that is frequently used in various facilities by the public. The general use of such computer systems increases the likelihood of germs and bacteria being built up or left in the vicinity of the computer system. Use of a sanitary liquid dispenser according to the present invention helps to reduce the likelihood of spread of germs and bacteria.

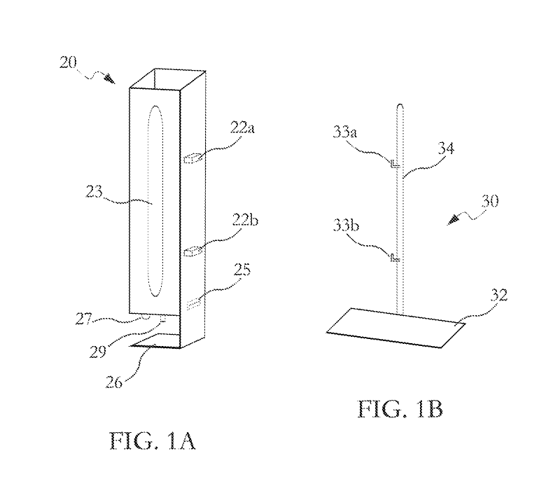

A sanitary liquid Dispenser 20 according to the present invention is depicted in FIG. 1A. The Dispenser 20 includes Clips 22a, 22b on the backside thereof. The Clips 22a, 22b provide a means to mount the Dispenser 20 in a stationary position. The Dispenser 20 further includes a clear view Opening 23. The Opening 23 allows the user to view the sanitary liquid levels within the Dispenser 20. An Outlet 29 provides a means for the dispensing of sanitary liquid for use by the user. A Bottom Lip 26 is provided that extends outwardly from the Dispenser 20. In one particular embodiment, Dispenser 20 includes an electronic Sensor 27 connected via USB cable or other connection device that activates the dispensing of sanitary liquid from the Dispenser 20. The electronic Sensor 27 (emission sensor) may be in the form of an electronic eye or card reader. The sensor 27 also transmits a signal to software residing on a hard drive or other storage medium in the computer. Prior to receiving the signal, the software deactivates the computer by placing the computer into sleep mode. Upon receipt of the signal from the sensor, the software activates the computer for use. The user therefore must use the Dispenser 20 prior to using the computer, if the user fails to use the Dispenser 20, then the computer remains deactivated in sleep mode.

The Dispenser 20 includes a wired and/or wireless connection to the computer. The connection provides a means to transmit signals to the computer to enable the computer for use. In one particular embodiment, an USB connection 25 may be used to supply power to the Dispenser 20 and transmit signals to the activation software residing on a hard drive or other storage medium in the computer. The Dispenser 20 may also be wired to the computer via alternative input means provided on the computer or other electronic device.

In reference to FIG. 1B a Stand 30 is depicted. The Stand 30 includes a Pedestal 34 where two Hooks 33a, 33b are provided thereon. The Stand 30 also includes a Base 32. The Stand 30 may be used to mount the Dispenser 20 thereon as a means to place the Dispenser 20 in a stationary position. Alternatively the Dispenser 20 may be attached directly to a device such as a computer monitor or other electronic device where hooks may be provided for attachment thereto.

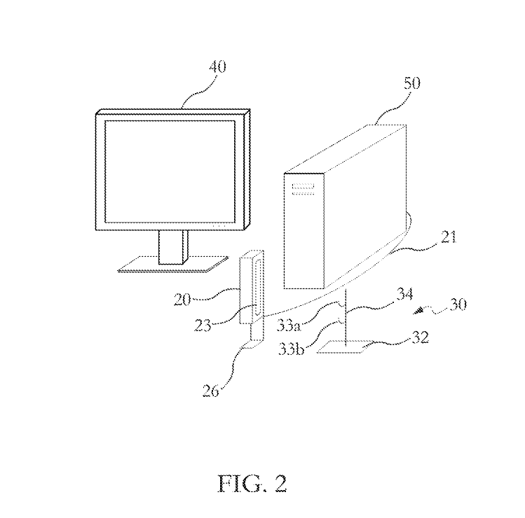

FIG. 2 depicts a perspective view of the Dispenser 20 and Stand 30 as used in conjunction with a Desktop Computer 50. As shown, a Dispenser 20 is connected via a Cord 21 and connected to the USB connection of the Computer 50. The USB connection provides a mean to power the Dispenser 20 and to transmit signals from the Sensor 27 to the Computer 50. Signals provide a means to activate the Computer 50 after sanitary liquid has been dispensed for use by the user. The Dispenser 20 may be mounted on a stand as described above near the Computer 50 or alternatively mounted directly on a Monitor 40 as shown in FIG. 2.

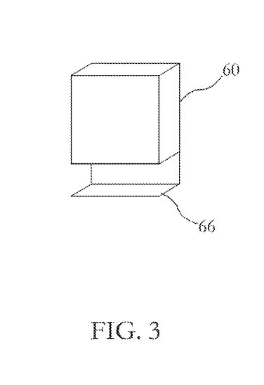

Referring to FIG. 3 an alternative embodiment, Dispenser 60, is depicted. The Dispenser 60 includes a Lip 66 that extends from the backside of the Dispenser 60. The Lip 66 also provides a base or means to support the Dispenser 60 on a flat surface for use thereof. The Dispenser 60 may also include the electronic sensor as described above with the prior embodiment. The Dispenser 60 is a standalone dispenser but also functions as described above with the Dispenser 20. The Dispenser 60 connects to an electronic device through the use of a USB connection and therefore limits the use of the electronic device it may be connected to.

The dispenser according to the present invention stores a container filled with sanitary liquid that is dispensed through an outlet and therefore provide a means to have a convenient mechanism for cleansing the user's hands. The hand sanitary liquid dispenser according to the present invention is especially useful in a health care situation where computers are used throughout a facility and health care professionals must frequently use the computer while caring for the patients in the vicinity of the computer station. Using the dispenser of the present invention provides convenient access to sanitizing liquid to cleanse ones hands. In one particular embodiment, the dispenser may be up to 9 inches in length and mounted upon the computer monitor through the use of brackets, screws, adhesive tape or placed in a stand beside the computer. The interior of the dispenser although not shown includes a container of sanitary liquid which may either be refilled or replaced with a full container. The use of the dispenser is especially useful in any situation where a plurality of people use a single computer station or other computerized device and therefore provides a means to reduce the spread of germs or bacteria. The instant invention has been shown and described in what it considers to be the most practical and preferred embodiments. It is recognized, however, that departures may be made there from within the scope of the invention and that obvious modifications will occur to a person skilled in the art.

What is claimed is:

1. A sanitary liquid dispenser for dispensing sanitary liquid and controlling use of an electronic device comprising:
a. an outlet, where said outlet includes a means for the dispensing of sanitary liquid from a container within the dispenser;
b. an emission sensor, where said emission sensor provides a means for dispensing sanitary liquid out of the outlet;
c. a bottom lip, where said lip extends outwardly from the dispenser; and
d. an electronic sensor, where said sensor transmits a signal to software residing on the electronic device and upon receipt of the signal, the software activates the electronic device for use.

2. The sanitary liquid dispenser according to claim 1, further comprising a means to attach the dispenser to the electronic device, where the means to attach includes at least one of a bracket, screw and adhesive tape.

3. The sanitary liquid dispenser according to claim 1, where the electronic sensor includes a card reader connected to the electronic device

4. The sanitary liquid dispenser according to claim 1, where the container of sanitary liquid is refillable.

5. The sanitary liquid dispenser according to claim 1, further including a stand where said stand provides a means to mount to the dispenser.

6. The sanitary liquid dispenser according to claim 1, where the dispenser includes a plurality of clips where said clips provide a means to mount the dispenser in a stationary position
